(19) United States
(12) Patent Application Publication
(10) Pub. No.: US 2010/0201625 A1
(43) Pub. Date: Aug. 12, 2010

(54) Wearable Computer Mouse And Electronic Device Controller

(76) Inventor: Walter Urbach, La Jolla, CA (US)

Correspondence Address: DUANE MORRIS LLP - San Diego, 101 WEST BROADWAY, SUITE 900, SAN DIEGO, CA, 92101-8285, US

(21) Appl. No.: 12/452,699

(22) PCT Filed: Jul. 15, 2008
(86) PCT No.: PCT/US2008/070087

§ 371 Date: Apr. 15, 2010

Related U.S. Application Data
(63) Continuation-in-part of application No. 11/879,131, filed on Jul. 16, 2007.

(51) Int. Cl. G06F 3/033

(52) U.S. Cl. 345/163

(57) ABSTRACT

A portable electronic device controller includes a housing wearable by a user and a controller disposed within the housing. The housing may be worn on the user's fingers and in particular may be worn on the proximal phalanges of the user. The electronic device controller may advantageously be a computer mouse that enables the user to control the cursor of a computer by manipulating controller elements with the thumb of the hand wearing the device. The user's fingers extend through openings in the electronic device controller and are free to move enabling the user to use the same hand to perform other functions such as operating a keyboard, driving or flying.

### RELATED APPLICATION

This application is a continuation-in-part that claims priority of U.S. Utility application Ser. No. 11/879,131, entitled Hand Integrated Mouse Platform, filed Jul. 16, 2007, the contents of which are herein incorporated by reference as if set forth in their entirety.

### FIELD OF THE INVENTION

The present invention relates, most generally, to a wearable electronic device controller, and more particularly to a remote control device such as a wireless computer mouse that may be worn on a user's hand.

### BACKGROUND

Cursor-positioning devices can be used to move a cursor to a desired position on a computer screen, to select text or graphics, to choose commands, or to operate other computer functions. One widely-used type of cursor-positioning device, commonly referred to as a “computer mouse” or simply “mouse”, consists of a main body which may be manipulated across a working surface such as a desktop or a “mousepad”. Common types of mouses incorporate a control element called a “trackball” which protrudes through an opening in the bottom of the mouse and comes in contact with the working surface. The trackball is free-floating, and therefore rotates as the mouse is manipulated across the working surface. Mechanisms inside the mouse detect the physical movements of the mouse, and electronic components translate these physical movements into electronic signals which are communicated to the computer to control the position of the cursor on the computer screen. One problem with a conventional computer mouse is that it is not always convenient or desirable to have a working surface over which to operate the mouse. Conventional mouse types may be wireless or coupled to the computer via a wire or other hardware.

A mouse may include different types of control elements, such as a trackball which is positioned so that it may be manipulated by the thumb or fingers rather than by being moved across a working surface. With other types of trackballs, the manipulations or movements of the trackball are detected by optical or electronic means, rather than mechanical means as is more common for trackballs which move across a working surface. Many computer mouse models include a scroll wheel or thumb wheel which can be rotated to move the cursor without physical movement of the mouse, either instead of or in addition to, a trackball which may be moved across a working surface. Mechanisms inside the mouse detect the manipulation of the scroll wheel or thumb wheel and electronic components such as switches translate these physical manipulations into electronic signals which are communicated to the computer to control the position of the cursor on the computer screen.

A conventional computer mouse may include a left (or “enter”) button and a right button. Pressing the left or right button is commonly referred to as a “left click” or a “right click”, respectively. Various computer functions can be controlled by pressing these buttons, depending on the position of the cursor and the software being run by the computer. Moreover, a “double left click” maneuver may be used for a variety of computer commands, and some types of mice have additional convenient features such as a third button. Mechanisms inside the mouse detect the manipulation, i.e. “clicking” of the buttons and electronic components translate such manipulations into electronic signals which are communicated to the computer to control the position of the cursor on the computer screen.

Despite the considerable variety of computer mice currently known and available on the market, a number of practical problems and drawbacks still exist. Typical operation of a computer involves data entry using the computer keyboard, combined with operation of the mouse. One problem with most known mouse types is that in order to use the mouse, the user has to move one hand an appreciable distance away from the keyboard, thus interrupting the data entry process and generally making the operation of the computer less efficient. Generally speaking, when one is manipulating a conventional computer mouse using a hand, that hand cannot be used to perform any other functions. Yet another problem with a wired mouse is that it must be operated within a fixed and limited distance from the computer terminal.

Various other electronic devices are operated by hand-held remote control devices. Examples include but are not limited to televisions, radios, stereo equipment, electronic games, lights, garage door openers, sound equipment, blinds, fans such as ceiling fans, automobiles and HVAC (heating, venting and air conditioning) devices, among others. Mechanisms inside the hand-held remote control devices detect the manipulation of various input mechanisms such as buttons, thumbwheels, joysticks and the like or receive inputs or commands from various sensors, and electronic components translate these physical manipulations or signals from the sensors, into electronic signals which are communicated to the electronic device to control various aspects of the electronic device. Conventional remote control devices are generally box-shaped or round and are held and operated by a user's hand. Since the user holds the remote control device in his or her hand, the user's hand is completely occupied operating the remote control device and cannot be used to carry out further functions.

Accordingly, there is a need for a computer mouse and numerous other electronic control devices that enable the user to control the cursor of the computer or other electronic device with one hand while allowing a user to perform other operations such as operating the keyboard, with the same hand.

### SUMMARY OF THE INVENTION

To address these and other needs, and in view of its purposes, provided is a portable and wearable controller device for controlling an electronic device either remotely or using a wired connection.

According to one aspect, provided is a computer mouse comprising a portable unit including a plurality of openings, each capable of receiving at least one finger of a user's hand extending therethrough and at least one of the openings capable of receiving an individual finger of the user's hand extending therethrough. The portable unit is a solid housing. At least one controller is disposed within the housing and is capable of controlling a cursor of the computer. The controller is operable at least by the hand of the user. The portable unit is wearable on the user's fingers.

According to another aspect, provided is portable controller device for remotely controlling an electronic device. The portable device comprises a portable unit with a plurality of openings, each capable of receiving an individual digit of a user's hand therethrough. The portable unit comprises a solid housing. At least one controller capable of remotely controlling an electronic device is disposed within the housing and operable at least by the hand of the user.

According to another aspect, a method for operating a computer is provided. The method includes providing a wireless mouse comprising a portable unit with a plurality of openings, each opening capable of receiving at least an individual finger of a user's hand extending therethrough and at least one opening for receiving only an individual finger of the user's hand extending therethrough. The portable unit comprises a solid housing. A controller capable of remotely controlling a cursor of the computer is operable at least by the user's hand and disposed within the housing. The method provides for wearing the wireless mouse on the user's hand by extending the individual fingers through corresponding openings, and manipulating the controller with the user's hand thereby sending a signal to and controlling the cursor.

The user may simultaneously perform other mechanical functions while operating the controller of the mouse.

### BRIEF DESCRIPTION OF THE DRAWING

The present invention is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing.

FIG. 1 is a perspective view showing an exemplary embodiment of the inventive wearable wireless mouse worn while keyboarding;

FIG. 2 is a perspective view showing an exemplary embodiment of the inventive wearable electronic device controller being worn while driving;

FIG. 3 is perspective view of an exemplary electronic device controller according to the invention;

FIG. 4 is a front view of the exemplary electronic device controller shown in FIG. 3;

FIG. 5 is a perspective view showing a further control element disposed on an exemplary electronic device controller according to the invention;

FIG. 6 is an end view at the a controller section of an exemplary electronic device controller according to the invention;

FIG. 7 is a perspective view of another exemplary electronic device controller according to the invention;

FIG. 8 is a front view of the exemplary electronic device controller shown in FIG. 7;

FIG. 9 is a perspective view of yet another exemplary embodiment of an electronic device controller according to the invention;

FIG. 10 is a perspective view showing a user driving a car wearing the exemplary electronic device controller of FIG. 9;

FIG. 11 is a front view of yet another exemplary embodiment of a wearable electronic device controller according to the invention;

FIGS. 12 and 13 are each perspective views of yet another exemplary embodiment of a wearable electronic device controller according to the invention;

FIG. 14 is a perspective view of yet another exemplary embodiment of a wearable electronic device controller according to the invention; and

FIG. 15 is a perspective view showing an exemplary electronic device controller being worn by a user while operating a keyboard and using the electronic device controller to control at least one electronic device.

### DETAILED DESCRIPTION

The present invention is directed to an electronic device controller that is a portable, wearable device for controlling electronic equipment such as a computer. The electronic device controller is in the form of a unit that includes one or more openings for receiving one or more fingers therethrough. The unit is a solid housing that includes at least one controller therein. The solid housing, i.e., protective cover, is advantageously shaped to form one or more openings, each for receiving at least one individual finger of a user extending therethrough, with at least one opening advantageously sized to receive only an individual finger extending therethrough, in various embodiments. The unit is a wearable device that can be advantageously worn on the proximal phalanges, not extending over the middle proximal interphalangeal joint of a user and includes in the housing one or more controllers with control elements that may be manipulated by the same hand upon which the device is being worn, most advantageously by the thumb, although the other fingers may also be used to manipulate the control elements. Control elements include but are not limited to a dial, wheel, ball, button, touch screen, joystick, piezoelectric devices, and motion detectors. Any suitable sensor responsive to touch, motion or sound may be used as a control element.

When the device is being worn such that the user's fingers extend through the opening of the unit, the thumb of the same hand of the user can advantageously be used to manipulate the control elements to operate the controller and send signals to a computer or other electronic device. The signals may be transmitted via free space or along hardware such as a wire. The device may be used as a remote controller to control various electronic devices such as but not limited to a computer, a telephone, a television, a car radio, sound equipment such as MP3 players, DVD players, CD players, a VCR, a camera, an automobile ignition, an automobile locking system, a garage door opener, an electronic game, lights, a fan, home theater components, entertainment systems, household appliances and blinds.

In one particularly advantageous embodiment, the present invention provides a portable wireless computer mouse, i.e., a cursor control device, wearable by a user. According to other exemplary embodiments, the wearable computer mouse may be electrically coupled to the computer by a wire.

The use of computer mouse systems, including wireless computer mouses, is known in the prior art. More specifically, computer mouse systems heretofore devised and utilized are known to consist basically of familiar, expected and obvious components that enable the computer mouse to generate a signal that controls, remotely or through a wire, the cursor and various other aspects of a computer. Computer mice are known to include a controller, sensors or mechanical or other input devices, i.e. control elements, one or more switches and electronic circuitry and generally operate under the principle whereby an input is delivered by manipulating a control element to impart a signal to a controller and responsive to the signal input to the controller, an outgoing signal is sent through free space or a wire to control the cursor and various other aspects of a computer. Various references are available and known in the art and which describe the operation of a computer mouse. The sensors and input means, switches, various control elements, electronic circuitry, signal transmission means and cursor control means are known in the art and the present invention provides a novel housing for a wireless computer mouse that may be worn by a user enabling the user to utilize full dexterity of the user's fingers while controlling the mouse, therefore enabling the user to simultaneously carry out another function using the same hand.

In other exemplary embodiments, the present invention is directed to a wearable unit with openings therethrough, the unit being a housing that contains one or more control devices for controlling other electronic devices. The art of wireless remote control devices for controlling electronic devices is also a mature art and the various conventional systems including control elements, switches, sensors, buttons and other input devices, electronic circuitry, and signal transmission means is well known in the art and will not be further described herein.

One aspect of the invention is the user's ability to perform one task enjoying full dexterity of the user's fingers while controlling an electronic device such as a cursor on a computer, with a controller operated by the thumb of the same hand of the user.

Now turning to the figures, it should be understood that the figures generally illustrate a wearable electronic device controller being worn or wearable on a user's right hand, but the wearable electronic device controller of the invention may similarly be constructed for and worn on the left hand of the user.

For brevity, throughout the specification, the inventive electronic device controller will be referred to as such throughout the specification. It should be understood that the electronic device controller in many applications is a wearable computer mouse device.

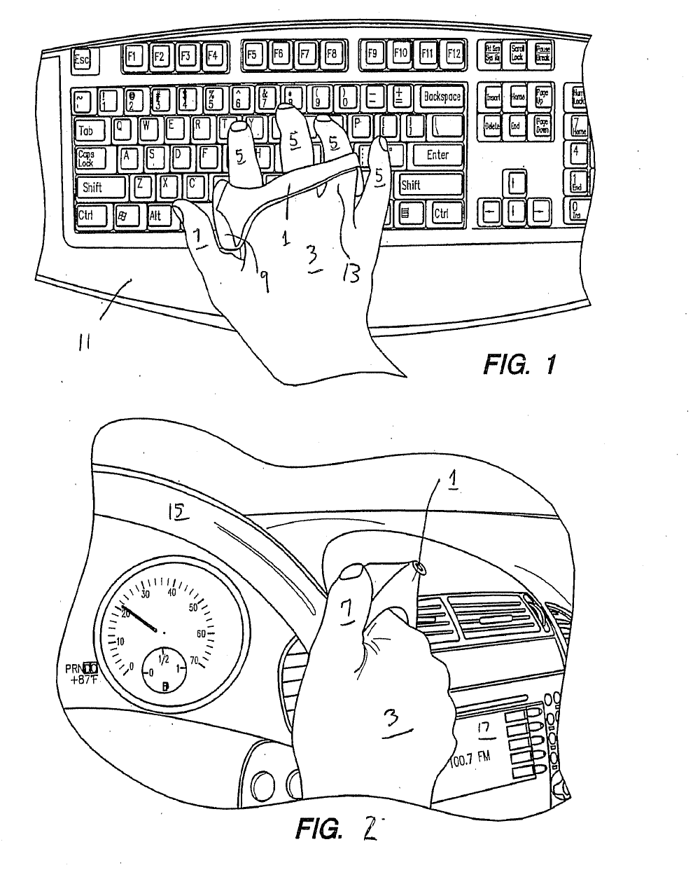

Now referring to FIG. 1, electronic device controller 1 is worn on hand 3 of a user. Fingers 5 extend through openings formed in electronic device controller 1 enabling thumb 7 to operate a heretofore described controller such as a computer mouse that is generally disposed within controller section 9 of electronic device controller 1. According to the embodiment illustrated in FIG. 1, electronic device controller 1 is generally worn on the proximal phalanges 13 of the user although electronic device controller 1 may be manipulated by thumb 7 which may move the orientation of electronic device controller 1 past the first, i.e. middle proximal, interphalangeal joint of the user, at times. In FIG. 1, fingers 5 are used for keyboarding on keyboard 11 while thumb 7 operates the controller of electronic device controller 1 which may be a computer mouse, to control the cursor of a computer, not showing.

FIG. 2 shows another exemplary use of the wearable electronic device controller. Electronic device controller 1 is worn on the fingers of hand 3 of the user, the same hand 3 used to operate steering wheel 15 of an automobile. According to the illustrated embodiment, electronic device controller 1 may be used to remotely control radio 17 of the automobile, although electronic device controller 1 may be used to additionally or alternatively control other electronic devices such as a mobile phone or GPS (global positioning system) according to various exemplary embodiments.

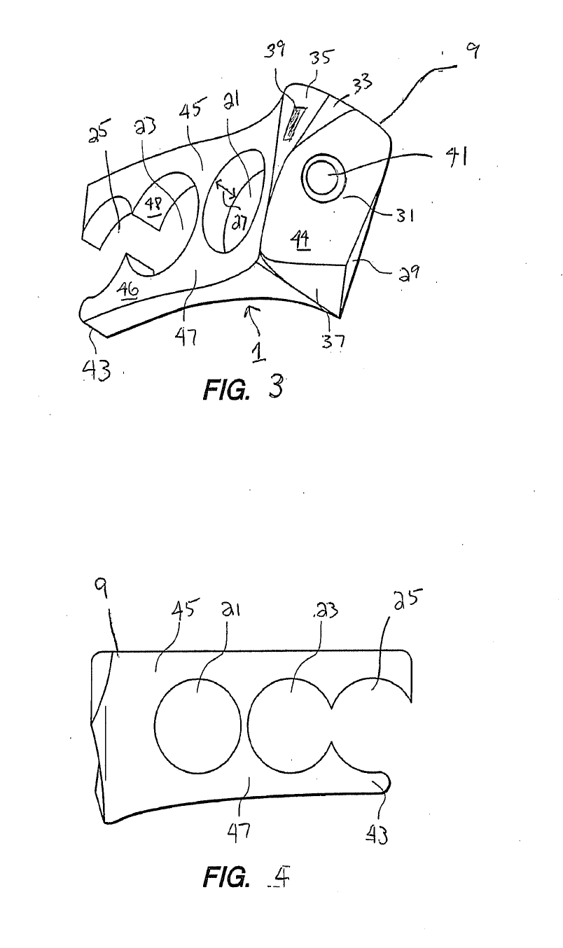

FIG. 3 is a perspective view showing electronic device controller 1 which may be a portable integral one-piece unit that includes openings 21, 23 and 25 each capable of receiving a user's finger therethrough. The unit is a solid housing that may be formed of various suitable durable and rigid materials such as but not limited to metal, plastics, polymers, various composites and wood. The housing may advantageously be formed of a rigid and inflexible material and may be a solid housing forming a continuous piece of material as used. In some exemplary embodiments, the housing may be formed of a plastic that may be minimally flexible or deformable. As such, it may be a one-piece unit or composed of multiple pieces joined together to form one continuous, solid piece. Within this solid housing may be one or more controllers, each capable of generating signal transmissions to remotely control an electronic device such as a cursor on a computer. In another exemplary embodiment, one or more of the controllers within the housing may generate signals via a wire or other hardware. Within the housing of electronic device controller 1 may also be a rechargeable or other power source such as a battery. The controller may generally be within controller section 9 which will be generally medially adjacent the user's thumb when the unit comprising the solid housing is worn on the hand of the user. Each of openings 21, 23 and 25 accommodate a digit of a user's hand and together with end member 43 provide stability and maneuverability to the unit that forms electronic device controller 1. A housing is known to be a protective cover or casing with components inside and, by solid housing, it is meant that the cover, i.e., housing, is solid such that each of surfaces 44, 46, 48 form outer surfaces of the housing.

According to one exemplary embodiment, distance 27 representing the thickness or depth of electronic device controller 1 at openings 21, 23, 25, i.e., when worn between the fingers, is chosen to be less than the average length of a human proximal phalanges. Thickness 27 may be less than about 15 millimeters but other thicknesses may be used in other exemplary embodiments. Controller section 9 will include a greater thickness, as illustrated, to accommodate various controller components therein.

As such, when worn by a user, the first interphalangeal joint and the mid and distal phalanges of the user's finger are free to move and enjoy complete dexterity. Controller section 9 may include a plurality of contour faces 29, 31, 33, 35 and 37 that face the user's thumb when worn. A control element such as exemplary ball 41 and pressure sensor 39 may be disposed on one or all of the contour faces and may each control different control unit disposed within controller section 9 of electronic device controller 1. In other words, exemplary ball 41 and pressure sensor 39 may be used to control different electronic devices.

FIG. 4 is a front view of the exemplary electronic device controller shown in FIG. 3. By “front” view, it is meant that this illustration depicts the proximal face of electronic device controller 1 which is a right-hand model to be worn on the user's right hand. FIG. 4 illustrates knuckle arm 45, i.e. the upper portion and lower arm 47, i.e. the lower arm of electronic device controller 1. It should be understood, however, that when the electronic device controller 1 is worn between the fingers of a user such as illustrated in FIGS. 1 and 2, lower arm 47 extends below the proximal phalanges of the user and does not extend beneath the palm of the user.

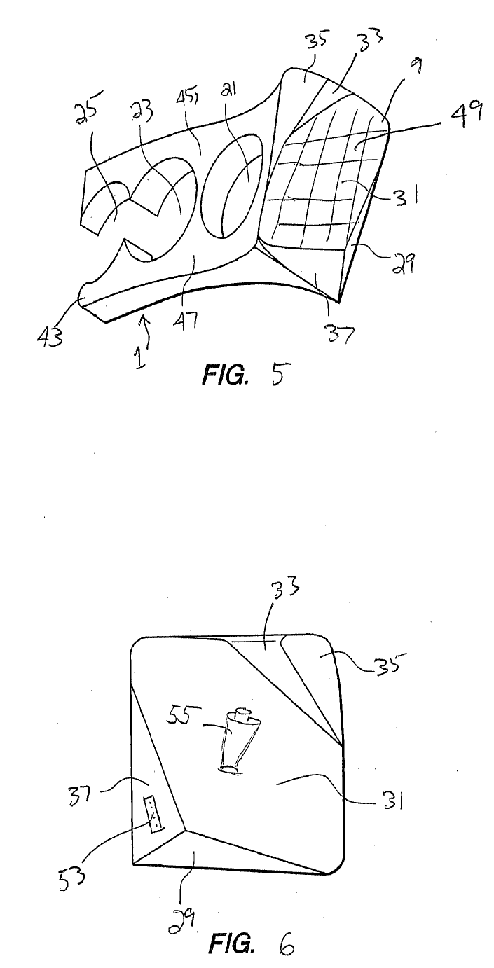

FIG. 5 is a perspective view substantially similar to the illustration of FIG. 3 and illustrates electronic device controller 1 with exemplary touch screen 49 on contour face 31. It should be understood that various other devices such as but not limited to a dial, wheel, ball, button, touch screen, joystick, piezoelectric devices, motion detectors, and the like may each be used as control elements for inputting a signal to the control device and thereby causing the controller to transmit or send a signal to control the computer or other electronic device. Any suitable sensor responsive to touch, motion or sound such as speakers, microphones, accelerometers, proximity sensors, may also be used as a control element. In various exemplary embodiments, the control element may generate a tone or other audible signal to indicate that the controller has received an input from the control element and has generated a signal to the computer or electronic device, according to conventional means for generating a tone.

FIG. 6 is a view of the controller section 9 end of the unit that faces the user's thumb and shows contoured faces 29, 31, 33, 35 and 37. FIG. 6 illustrates motion sensor 53 and joystick 55 on contoured surfaces 37 and 31, respectively such as may serve as control elements. Motion sensor 53 may be any suitable motion sensor such as known in the art and may be a motion sensor that senses the position of the user's thumb relative to the motion sensor or the motion, i.e. orientation, of electronic device controller 1.

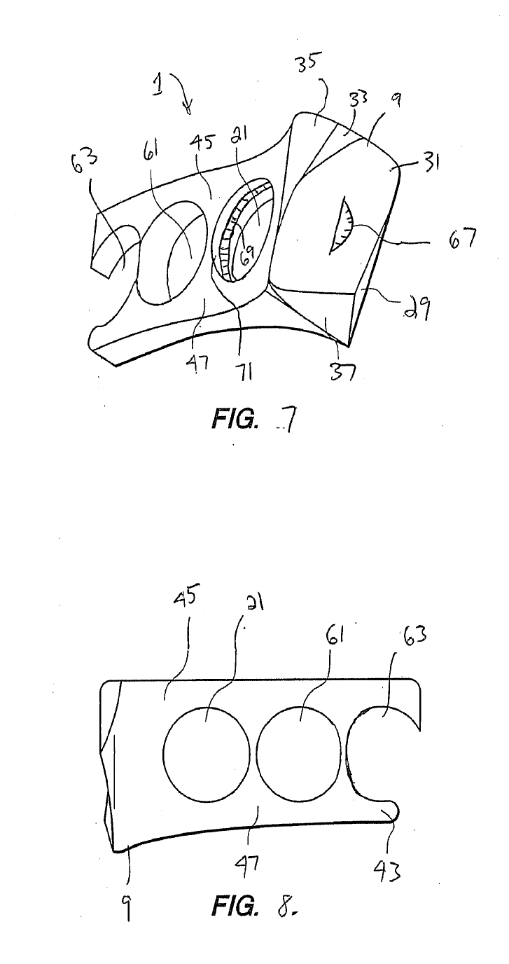

FIG. 7 shows an exemplary electronic device controller similar to the one illustrated in FIG. 5 but distinguished by a solid wall between second and third openings 61, 63 and also illustrating exemplary thumb wheel 67 as a control element on contoured surface 31 of controller section 9. Pressure sensor 69 is disposed on inner surface 71 of opening 21 and may be a conventional pressure sensor that may be used to activate or deactivate a corresponding controller or controllers in controller section 9, using conventional means. In the illustrated embodiment, pressure sensor 69 extends completely around inner surface 71, but in other exemplary embodiments, pressure sensor 69 may extend only partially around inner surface 71.

FIG. 8 is a front view showing the exemplary electronic device controller embodiment shown in FIG. 7 and also illustrates the solid wall between second and third openings 61, 63. It can be seen that each of openings 21, 61 and 63 are generally round in shape. In other exemplary embodiments, either or all of openings 21, 61 and 63 may take on various other shapes suitable to receive a user's finger extending therethrough.

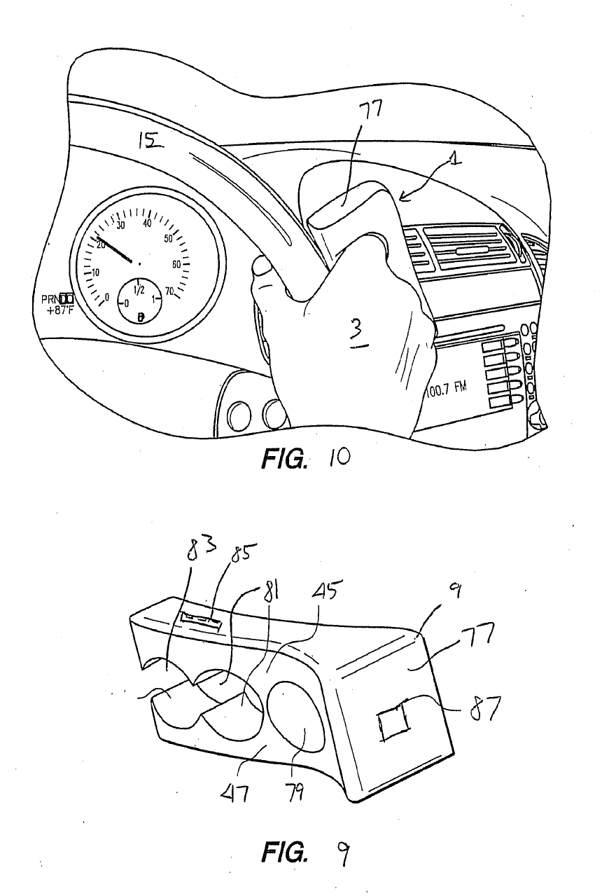

FIG. 9 shows another exemplary electronic device controller and illustrates controller section 9 having a substantially flat face 77 that faces the user's thumb when the electronic device controller is worn on a user's hand. Electronic device controller 1 includes openings 79, 81 and 83, each of which are generally round and for receiving a user's finger therethrough. Control element 87 may be any suitable control element used to send a signal to a controller such as previously described or as known in the art. FIG. 9 also illustrates exemplary jack 85 which may receive a plug connected to a power source such as may be used to recharge a power source contained within the housing that defines electronic device controller 1.

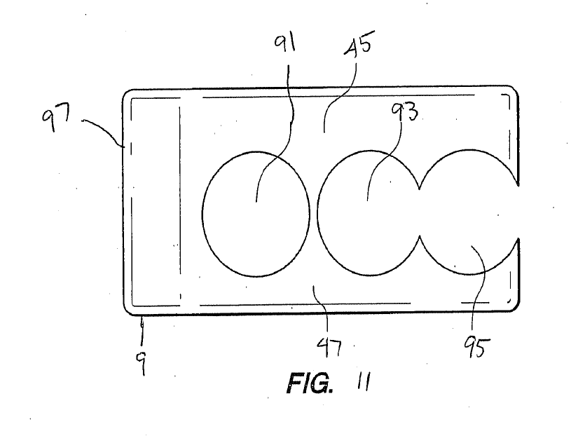

FIG. 10 shows the exemplary electronic device controller 1 shown in FIG. 9, being worn on a user's hand 3 while operating steering wheel 15 of an automobile. Electronic device controller 1 may be used to control the automobile radio, a GPS, a mobile phone or other sound system such as an ipod or CD player according to various exemplary embodiments.

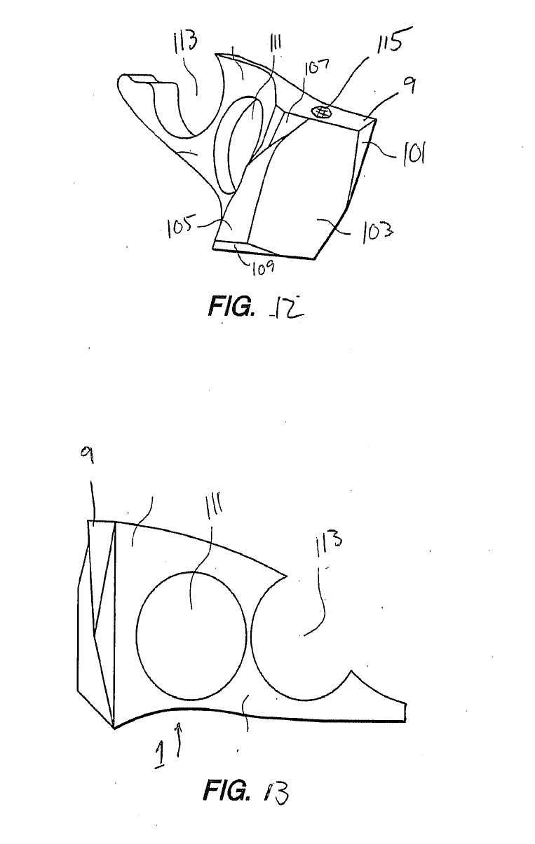

FIG. 11 shows another exemplary electronic device controller 1 which has a generally rectangular shape as viewed from the front, and includes controller section 9 and openings 91, 93 and 95 each for receiving a single digit of a user. End face 97 of controller section 9 may be essentially flat and may include one or more controller elements thereon. The various components of the controller are disposed within controller section 9.

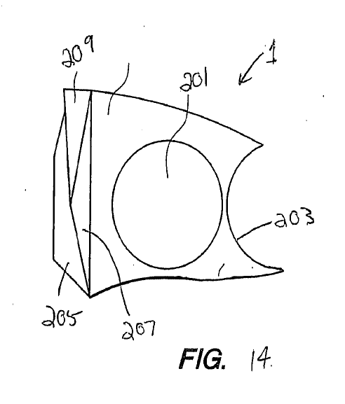

FIGS. 12 and 13 are perspective views showing another exemplary electronic device controller of the invention. Electronic device controller 1 includes controller section 9 with contour faces 101, 103, 105, 107, and 109 which may each include a control element thereon and are each in confronting relationship with various positions of a user's thumb within the normal range of motion through which the thumb may be moved. Electronic device controller 1 also includes opening 111 and receptacle 113 each for receiving a user's finger extending therethrough. Although receptacle 113 includes an inner surface that extends about 270-300 degrees about a user's finger, such is exemplary only and the surfaces that define receptacle 113 may extend circumferentially to a greater or lesser extent. Microphone 115 is disposed in controller section 9 and receives voice commands from which the controller generates transmission signals to control a computer cursor or various other electronic devices, according to conventional methods.

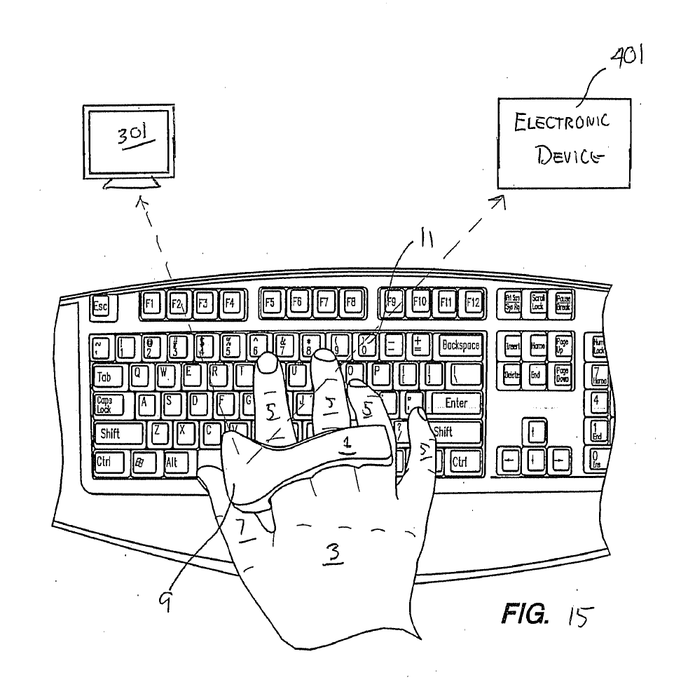

FIG. 14 shows another exemplary electronic device controller 1 and includes only a single opening 201 for receiving a user's finger extending therethrough. The exemplary electronic device controller 1 shown in FIG. 14 may also include a thickness (see FIG. 3) less than the thickness of an average proximal phalanges of a human. When the user's first finger extends through opening 201, the user's middle finger may rest along contour surface 203 to maintain the electronic device controller 1 in desired orientation such that the user's thumb may access one or more control elements that may be disposed on contour surfaces 205, 207, 209 in controller section 9 of electronic device controller 1.

FIG. 15 shows an exemplary electronic device controller 1 worn on user's hand 3 while user's hand 3 operates keyboard 11 and the user's thumb 7 simultaneously operates the controller to control computer 301 and/or electronic device 401. According to this exemplary embodiment, electronic device controller 1 may be a wearable mouse capable of controlling the cursor of computer 301 responsive to the user's thumb 7 manipulating a control element within control section 9 of electronic device controller 1. Electronic device 401 which may be any of various electronic devices controllable by a remote control including but not limited to a telephone, a television, a car radio, sound equipment, a camera, an automobile ignition or security system, a garage door opener, an electronic game, lights, a fan, home theater components, household appliances and blinds. According to another exemplary embodiment, electronic device controller 1 may control electronic device 401 responsive to the user's thumb 7 manipulating a control element within control section 9 of electronic device controller 1.

According to yet another exemplary embodiment, electronic device controller 1 may include more than one controller operated by different control elements and may be used to control each of computer 301 and electronic device 401 or multiple electronic devices such as electronic device 401.

The dexterity provided by the strap-free solid one piece integral housing which includes a thickness that enables the device to be worn on a user's proximal phalanges enables the user complete dexterity of the fingers and allows a user's hands to perform various other functions. It should be understood that the illustrated examples of operating the car and keyboarding, are intended to be exemplary only and the user's hand may be used to perform virtually any other function such as flying an airplane, operating equipment, and so forth, while wearing the inventive portable controller device. It should also be noted that, while wearable on the proximal phalanges of the user, the user may prefer to wear the inventive portable controller device on the mid-phalanges.

The preceding merely illustrates the principles of the invention. It will thus be appreciated that those skilled in the art will be able to devise various arrangements which, although not explicitly described or shown herein, embody the principles of the invention and are included within its spirit and scope. In particular, the various designs and configurations of the inventive electronic device controller 1 are intended to be representative and not limiting of the various designs and configurations within the scope of the invention.

Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A computer mouse comprising:
a portable unit including a plurality of openings, each capable of receiving at least one finger of a user's hand extending therethrough and at least one of said openings capable of receiving an individual finger of said user's hand extending therethrough, said portable unit being a solid housing; and
a controller disposed within said solid housing and capable of controlling a cursor of said computer, said controller operable at least by said hand of said user, said portable unit wearable on said user's fingers.

2. The computer mouse as in claim 1, wherein said computer mouse is a wireless mouse and said controller is capable of remotely controlling a cursor of said computer.

3. The computer mouse as in claim 1, wherein said portable unit includes a depth, at said plurality of openings, no greater than about 10 millimeters.

4. The computer mouse as in claim 1, wherein said portable unit is wearable on proximal phalanges of said user's fingers and does not extend beneath said user's palm when worn.

5. The computer mouse as in claim 1, further comprising at least one sensor disposed on an inside surface of at least one said opening, said at least one sensor capable of generating signals responsive to contact of said sensor, and which activate said controller.

6. The computer mouse as in claim 1, wherein each said opening is essentially round.

7. The computer mouse as in claim 1, wherein said controller is disposed within a controller portion of said solid housing, said controller portion medially adjacent said user's first finger and including a plurality of contoured faces contactable by said user's thumb, said controller operable by at least said user's thumb.

8. The computer mouse as in claim 1, wherein each said opening receives only one corresponding finger of said hand of said user and said controller is operable by said thumb of said user's hand.

9. The computer mouse as in claim 1, wherein said controller includes at least one of a dial, a wheel, a joystick, a touch screen, a piezoelectric device, a motion detector, a microphone and a laser.

10. The computer mouse as in claim 1, wherein said solid housing is comprised of one of plastic, a composite material, metal and wood.

11. The computer mouse as in claim 1, further comprising a rechargeable power source disposed within said solid housing.

12. The computer mouse as in claim 1, wherein said controller generates signals that remotely control said cursor of said computer, said signals corresponding to and responsive to manipulation of said controller, said manipulation comprising at least one of physically manipulating said controller and manipulating said controller using voice commands.

13. The computer mouse as in claim 1, further comprising a further controller disposed within said solid housing, said further controller capable of controlling a further electronic device.

14. The computer mouse as in claim 1, wherein said plurality of openings are in fixed position with respect to one another.

15. The computer mouse as in claim 1, wherein at least one of said plurality of openings extends through said solid housing.

16. A method for operating a computer, comprising:
providing a wireless mouse including a portable unit with a plurality of openings, each said opening capable of receiving at least an individual finger of a user's hand extending therethrough and at least one said opening for receiving only an individual finger of said user's hand extending therethrough, said portable unit comprising a solid housing, and a controller capable of remotely controlling a cursor of said computer, said controller operable at least by said hand of said user and disposed within said housing;
wearing said wireless mouse on said user's hand by extending said user's fingers through corresponding ones of said openings; and
manipulating said controller with said user's hand thereby sending a signal to and controlling said cursor.

17. The method as in claim 16, further comprising operating a further device with said fingers of said hand simultaneously along with said manipulating, and wherein said further device comprises one of an electronic device and a mechanical device.

18. The method as in claim 17, wherein said further device comprises a keyboard of said computer.

19. The method as in claim 16, wherein said providing a wireless mouse further comprises said solid housing including therein a further controller capable of remotely controlling a further electronic device.

20. The method as in claim 16, further comprising manipulating said controller using voice commands and activating said controller by contacting a sensor disposed on an inner surface of at least one of said openings.

21. The method as in claim 16, wherein said wearing comprises wearing said wireless mouse on proximal phalanges of said user's hand and said manipulating comprises manipulating a control element that communicates with said controller, with said user's thumb.

22. The method as in claim 16, further comprising generating an audible tone when said signal is sent.

23. The method as in claim 16, wherein said plurality of openings of said portable unit are in fixed position with respect to one another.

24. The method as in claim 16, wherein at least one of said plurality of openings of said portable unit extends through said solid housing.

25. A controller device for remotely controlling an electronic device, said device comprising:
a portable unit with a plurality of openings, each capable of receiving an individual digit of a user's hand therethrough and said portable unit being a solid housing, and
a controller capable of remotely controlling an electronic device, said controller disposed within said housing and operable at least by said user's hand.

26. The controller device as in claim 25, wherein said portable unit is wearable on said user's fingers and includes a depth, at said plurality of openings, no greater than about 10 mm.

27. The controller device as in claim 25, wherein said controller is disposed medially adjacent said user's first finger, includes a plurality of contoured surfaces facing said user's thumb, and is operable by said user's thumb.

28. The controller device as in claim 25, wherein said electronic device comprises one of a computer, a telephone, a television, a car radio, sound equipment, a DVD player, a CD player, a VCR, a camera, an automobile ignition, an automobile locking system, a garage door opener, an electronic game, lights, a fan, home theatre components, household appliances and blinds.

29. The controller device as in claim 28, further comprising a further controller capable of controlling a further electronic device and disposed within said solid housing, and
wherein said further electronic device comprises one of a computer, a telephone, a television, a car radio, sound equipment, a DVD player, a CD player, a VCR, a camera, an automobile ignition, an automobile locking system, a garage door opener, an electronic game, lights, a fan, home theatre components, household appliances and blinds.

30. The controller device as in claim 25, wherein said plurality of openings are in fixed position with respect to one another.

31. The controller device as in claim 25, wherein at least one of said plurality of openings extends through said housing.
